(19) United States
(12) Patent Application Publication
(10) Pub. No.: US 2013/0061452 A1
(43) Pub. Date: Mar. 14, 2013

(54) FASTENER AND METHOD OF INSTALLING SAME

(71) Applicant: John D. PRATT, Laguna Niguel, CA (US)

(72) Inventor: John D. PRATT, Laguna Niguel, CA (US)

(21) Appl. No.: 13/617,267

(22) Filed: Sep. 14, 2012

Related U.S. Application Data
(60) Provisional application No. 61/534,497, filed on Sep. 14, 2011.

(51) Int. Cl. F16B 13/06; B23P 11/00

(52) U.S. Cl. 29/525.02; 411/34

(57) ABSTRACT

A fastener comprises a body having a head with an exposed surface at a first end, a tapered ramp at a second end, a cylindrical shank disposed between the head and the tapered ramp, and a cylindrical passage formed through the body between the first and second end. The fastener further includes a cylindrical corebolt disposed within the passage of the body and having an enlarged head at a first end and a sleeve having a cylindrical passage therethrough and movably disposed over a portion of the corebolt. A drive nut is disposed on the corebolt and includes a leading edge disposed adjacent the exposed surface of the enlarged head of the body. The leading edge of the drive nut is rotationally coupled to protrusions extending outwardly from the head of the body.

### CROSS REFERENCE TO RELATED APPLICATIONS

This application claims the benefit of Pratt U.S. Provisional Application Ser. No. 61/534,497, filed on Sep. 14, 2011, and entitled “Fastener and Method of Installing Same.”

### BACKGROUND

1. Field of the Disclosure

The present disclosure relates generally to fasteners for assembly of two or more panels of a workpiece, and more particularly to a threaded blind fastener lacking a drive recess in a head thereof and wherein rotation of a body of the fastener is restrained by engagement of the head with a separate drive nut.

2. Description of the Background

Exterior airframe joints are required to be aerodynamic to reduce drag. It is therefore desirable to prevent any portion of a mechanical fastener from protruding beyond a surface of an outer panel of a workpiece in which the fastener is installed. It is also preferred to prevent any portion of a fastener from being recessed within the workpiece or recessed as compared to the remainder of the fastener. Having all portions of the fastener and the surface of the outer panel of the workpiece in an even plane is referred to as the “flushness” of the fastener. It is further desired to minimize the visibility of mechanical fasteners on an aircraft's exterior in order to improve appearance. Such flushness and appearance goals are easily met with conventional fasteners such as solid rivets, lock bolts, and threaded pins with nuts. Many pull-type blind fasteners also exhibit acceptable installed flushness. However, threaded blind bolts have always suffered from the need to have a corebolt break-off location vary by as much as 0.103 inch so that, in some grip conditions, the corebolt either protrudes above the surface of the outer panel by this amount or, if the break-off location is positioned to never break above the exposed body head surface, the corebolt breaks low, thereby leaving a cavity up to 0.103 inch deep. In either case, the fastener oftentimes requires milling of the protruding corebolt or filling (potting) of the cavity to produce the desired level of aerodynamic flushness.

Shaving of protruding corebolts and tops of flush fastener heads poses little difficulty with robotic installation equipment. However, recesses must still be filled prior to painting.

Another concern with typical blind fasteners having drive recesses is related to the weakening of the head of the blind fastener due to the driving recesses. In fact, driving recesses allow the head of the fastener to deform more easily when subject to off-axis loading, as in a lap joint. Testing has shown that elimination of driving recesses can improve the ultimate joint strength by as much as 30% or more with fasteners having 130 degree included angles, as are used in laminated composite structures.

A need therefore exists for a threaded blind fastener that may be installed without driving recesses in the head thereof and that may be shaved, if necessary, to produce an aerodynamic and aesthetic appearance.

### SUMMARY

According to one aspect of the present disclosure, a fastener includes a body having a head with an exposed surface at a first end, a tapered ramp at a second end, a cylindrical shank disposed between the head and the tapered ramp, and a cylindrical passage formed through the body between the first and second end. A cylindrical corebolt is disposed within the passage of the body and includes an enlarged head at a first end. The fastener further includes a sleeve having a generally cylindrical passage therethrough and movably disposed over a portion of the corebolt and a drive nut disposed on the corebolt and having a leading edge disposed adjacent the exposed surface of the enlarged head of the body. Still further, the fastener includes means for rotationally coupling the drive nut and the body.

In a further aspect of the present disclosure, a fastener includes a body having a head with an exposed surface at a first end, a tapered ramp at a second end, a cylindrical shank disposed between the head and the tapered ramp, and a cylindrical passage formed through the body between the first and second end. The fastener further includes a cylindrical corebolt disposed within the passage of the body and having an enlarged head at a first end and a sleeve having a cylindrical passage therethrough and movably disposed over a portion of the corebolt. A drive nut is disposed on the corebolt and includes a leading edge disposed adjacent the exposed surface of the enlarged head of the body. The leading edge of the drive nut is rotationally coupled to protrusions extending outwardly from the head of the body.

In a different aspect of the present disclosure, a method of installing a fastener in a workpiece includes the step inserting a fastener into a workpiece. The fastener includes a body having a head with an exposed surface at a first end, a tapered ramp at a second end, a cylindrical shank disposed between the head and the tapered ramp, and a generally cylindrical passage formed through the body between the first and second ends. The fastener further includes a cylindrical corebolt disposed within the passage of the body and having an enlarged head at the first end and a sleeve having a cylindrical passage therethrough and movably disposed over a portion of the corebolt. Still further, the fastener includes a drive nut disposed on the corebolt and having a leading edge disposed adjacent the exposed surface of the enlarged head of the body. The method further includes the steps of coupling the drive nut and the body, rotating the corebolt while rotationally restraining the drive nut and the body, and forming a blind head against the workpiece with the sleeve.

### BRIEF DESCRIPTION OF THE DRAWINGS

FIG. 1 is a top isometric view of a first embodiment of a fastener of the present disclosure that may be used to connect two or more panels forming a workpiece, by a single operator or mechanic, or an automatic fastening apparatus, such as a robot;

FIG. 2 is a side elevational view of the fastener of FIG. 1;

FIG. 3 is a is a cross-sectional view taken generally along the lines 3-3 of FIG. 2 and illustrating the fastener of FIG. 1 having a body, a translating threaded corebolt disposed within the body and having a breaking groove, a sleeve disposed over the corebolt and adjacent a tapered ramp of the body, and a drive nut disposed around the corebolt and adjacent an enlarged head of the body;

FIG. 4A is a side elevational view of the fastener of FIG. 1 partially installed within a workpiece;

FIG. 4B is an enlarged partial view of the section of FIG. 4A depicting the workpiece with the body and corebolt in phantom;

FIG. 5 is a cross-sectional view taken generally along the lines 5-5 of FIG. 4A;

FIG. 6 is a top isometric view of the fastener of FIG. 1 fully installed within the workpiece;

FIG. 7 is a side elevational view of the fastener of FIG. 1 in the installation phase of FIG. 6;

FIG. 8 is a cross-sectional view taken generally along the lines 8-8 of FIG. 7;

FIG. 9 is a top isometric view of the fastener of FIG. 1 fully installed within the workpiece and after shaving of the fastener;

FIG. 10 is a side elevational view of the fastener in the installation phase of FIG. 9;

FIG. 11 is a cross-sectional view taken generally along the lines 11-11 of FIG. 10 and depicting the installation phase of FIG. 9;

FIG. 12 is a top isometric view of a body for use with any of the fasteners disclosed herein;

FIG. 13 is a side elevational view of the body of FIG. 12 depicting a passage through the body in phantom;

FIG. 14 is a bottom isometric view of a drive nut for use with any of the fasteners disclosed herein;

FIG. 15 is a side elevational view of the drive nut of FIG. 14 depicting a threaded bore of the drive nut in phantom;

FIG. 16A is a bottom isometric view of the drive nut of FIG. 14 after partial installation of the fastener; and

FIG. 16B is an enlarged partial view of the section of FIG. 16A depicting malleable leading edge of the drive nut that has been deformed during installation of a fastener.

Other aspects and advantages of the present disclosure will become apparent upon consideration of the following detailed description, wherein similar structures have like or similar reference numerals.

### DETAILED DESCRIPTION

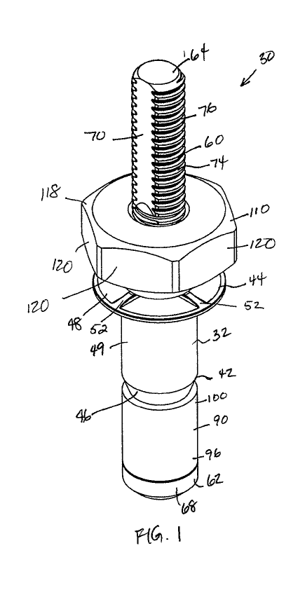

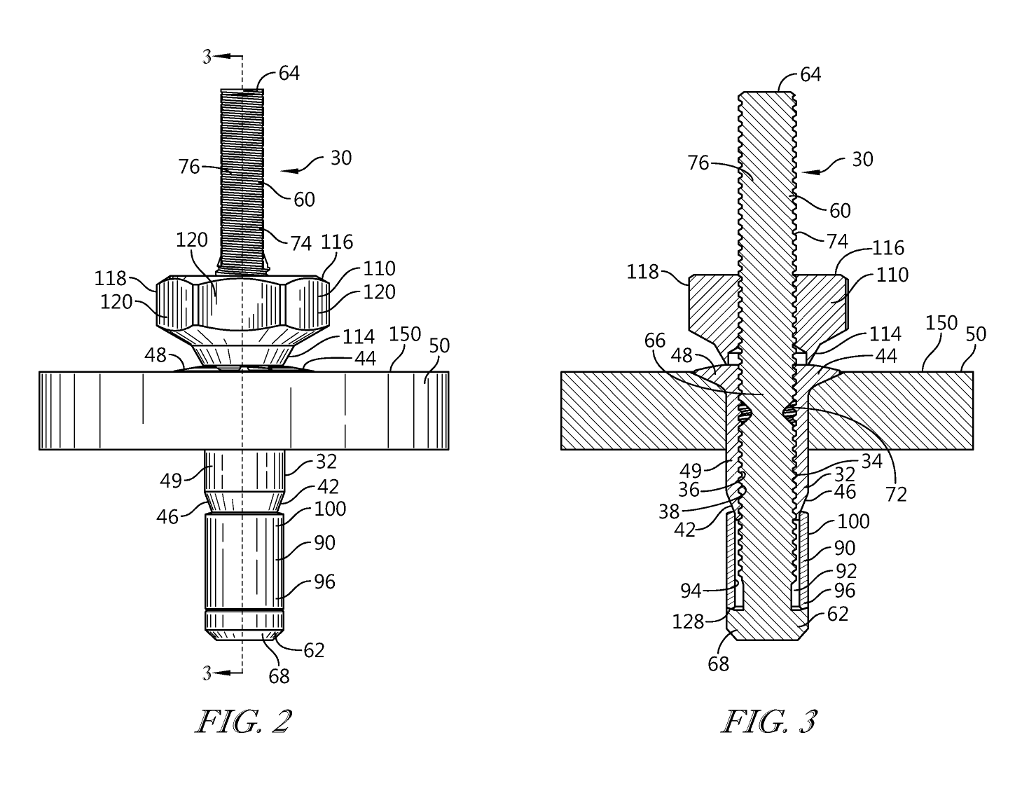

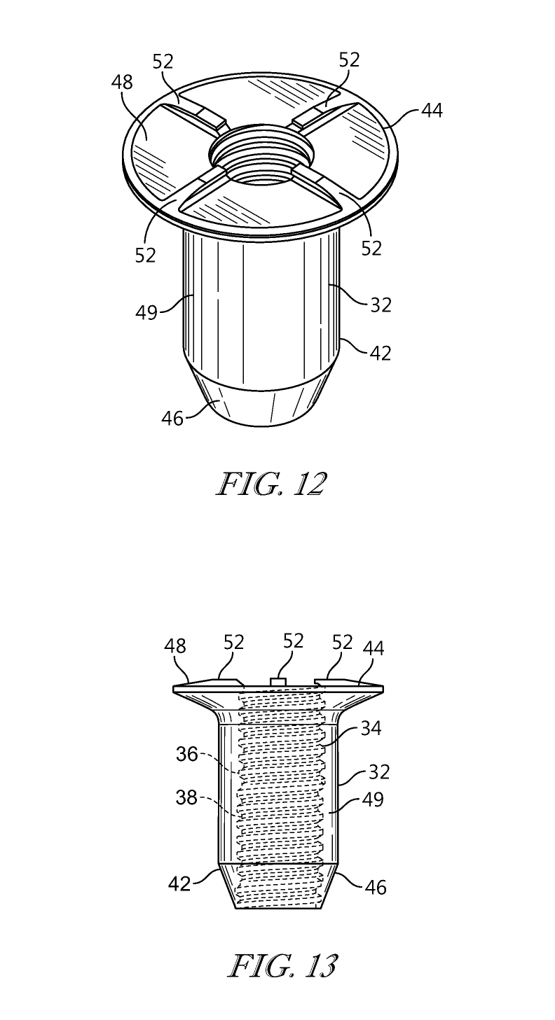

Referring to FIGS. 1-3, a first embodiment of a fastener or blind bolt 30 in accordance with the present disclosure includes a generally cylindrical body 32 having a passage 34 disposed through a central portion of the body 32. Also referring to FIGS. 12 and 13, an inner surface 36 of a wall 38 forming the passage 34 is threaded between first and second ends 42, 44 of the body 32. The body 32 further includes a tapered ramp 46 disposed on an outer surface of the body 32 at the first end 42, an enlarged head 48 is disposed at the second end 44 of the body 32, and a generally cylindrical shank 49 disposed between the first and second ends 42, 44. The enlarged head 48 is adapted to be seated within a countersunk panel or workpiece 50 (FIGS. 2 and 3). As can been seen from FIGS. 1 and 12, the enlarged head 48 does not include any driving recesses, but rather, includes a plurality of optional radial projections 52, as will be discussed in greater detail hereinafter.

A generally cylindrical corebolt 60, as seen in FIGS. 1-3, is concentrically disposed within the passage 34 of the body 32. As best seen in FIG. 3, the corebolt 60 includes first and second ends 62, 64 and a central portion 66 disposed between the first and second ends 62, 64. The corebolt 60 includes an enlarged head 68 disposed at the first end, opposing wrenching flats 70 (FIG. 1) disposed at the second end 64, a circumferential break groove 72 formed in the central portion 66, and threading 74 extending from the second end 64 and which stops short of the enlarged head 68, with the threading 74 being interrupted at the break groove 72. A pintail 76 is formed between the break groove 72 and the second end 64 of the corebolt 60, wherein the pintail 76 can be discarded after completion of installation, as will be discussed in greater detail hereinafter. Although wrenching flats 70 are depicted, in particular for rotation of the corebolt 60, other means may be utilized for rotation of the corebolt 60. Such means include, but are not limited to, a multi-sided trapezoidal profile, splines, knurls, a non-circular cavity such as an Allen or Phillips recess, and the like, and combinations thereof. Still optionally, an additional component may be attached to the corebolt 60 to facilitate rotation of the corebolt 60 in relation to the body 32, such as a press-fitted driver

Again referring to FIGS. 1 and 2, the fastener 30 further includes a deformable cylindrical sleeve 90 having a throughbore 92. An inner surface 94 forming the throughbore 92 is generally cylindrical in that it has no surface indentations or projections. A first end 96 of the sleeve 90 is positioned around the first end 62 of the corebolt 60 adjacent the enlarged head 68 and a second end 100 of the sleeve 90 is positioned adjacent the first end 42 of the body 32.

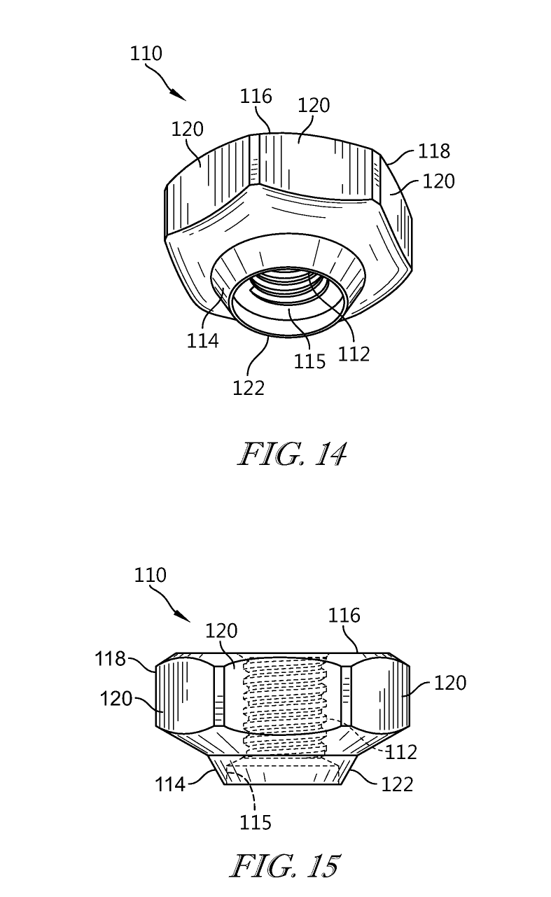

The fastener 30 further includes a drive nut 110, as seen in FIGS. 1-3, 14, and 15. The drive nut 110 generally includes a threaded bore 112 extending from a first end 114 to a counterbore 115 in a second end 116 of the drive nut 110, with the counterbore 115 being unthreaded. At the second end 116, the drive nut 110 includes an outwardly projecting perimeter 118 having a plurality of wrenching surfaces 120. A malleable leading edge or lip 122 is disposed at the first end 114 of the drive nut 110. Malleable materials suitable for the drive nut include mild steels, aluminum alloys, and the like. When the fastener 30 is assembled, the drive nut 110 is disposed in threaded engagement with the corebolt 60 with the malleable leading edge 122 of the drive nut 110 disposed adjacent the enlarged head 48 of the body 32.

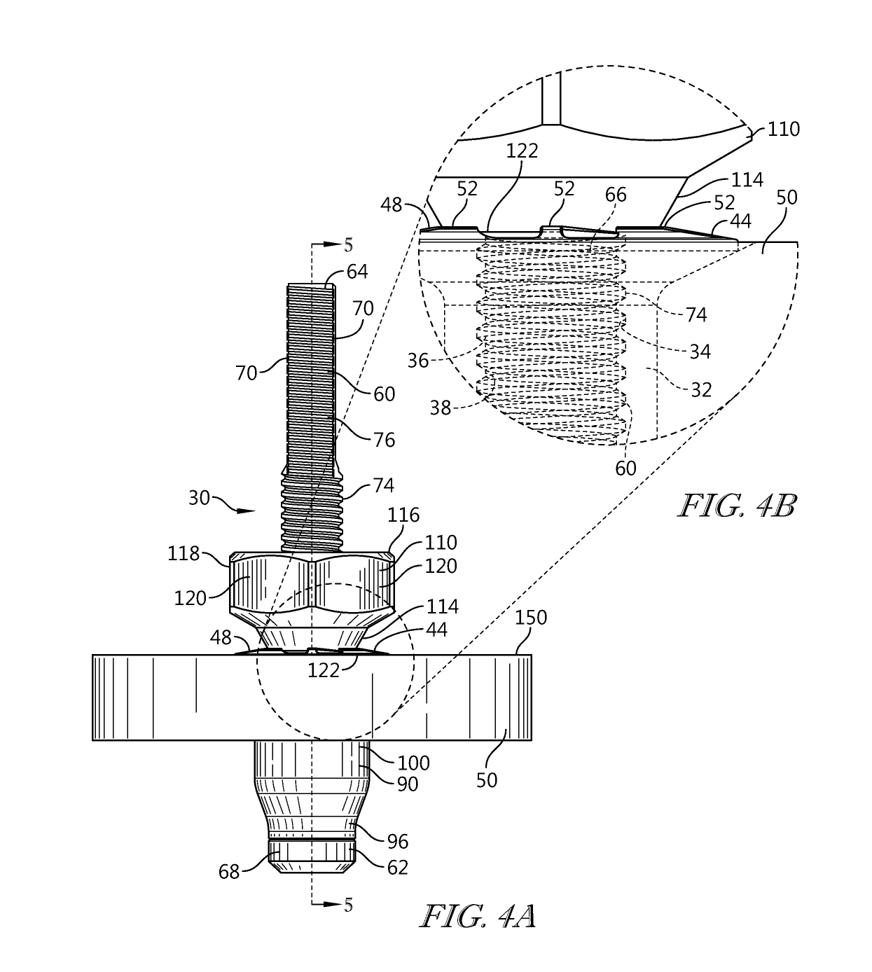

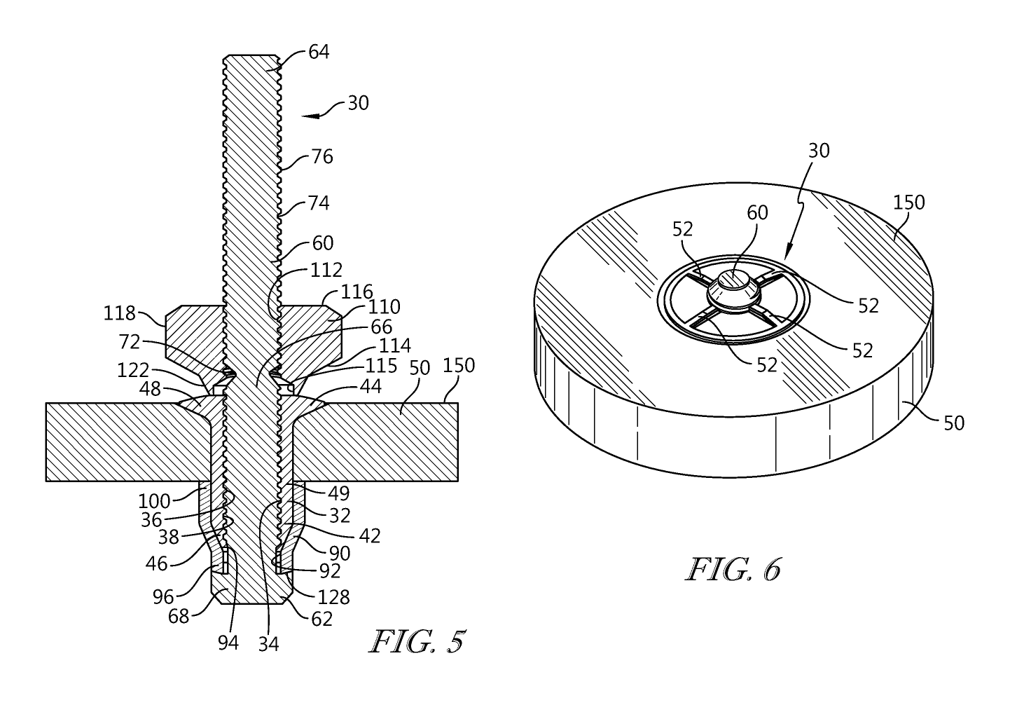

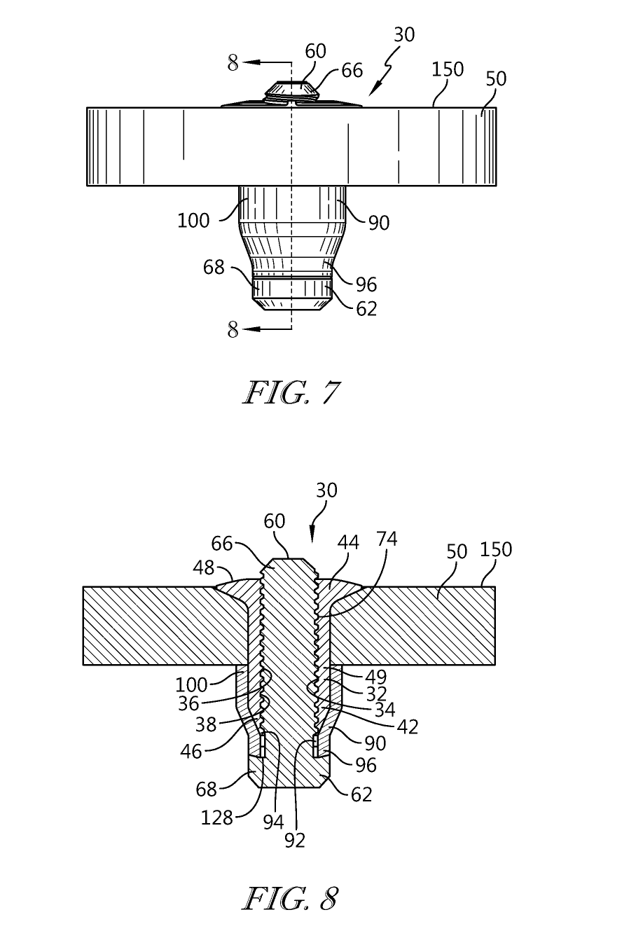

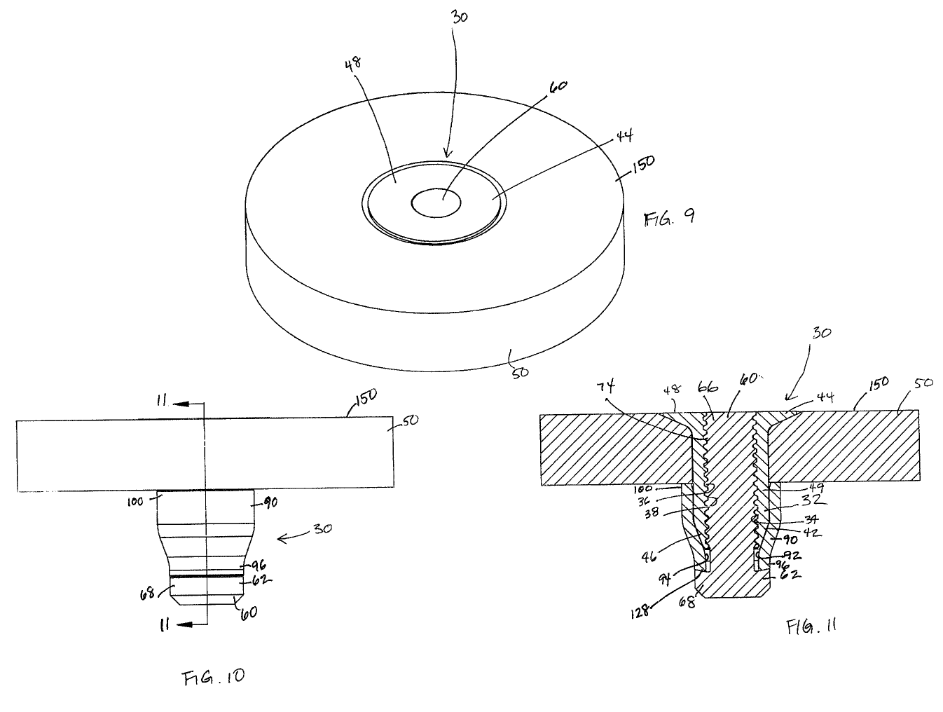

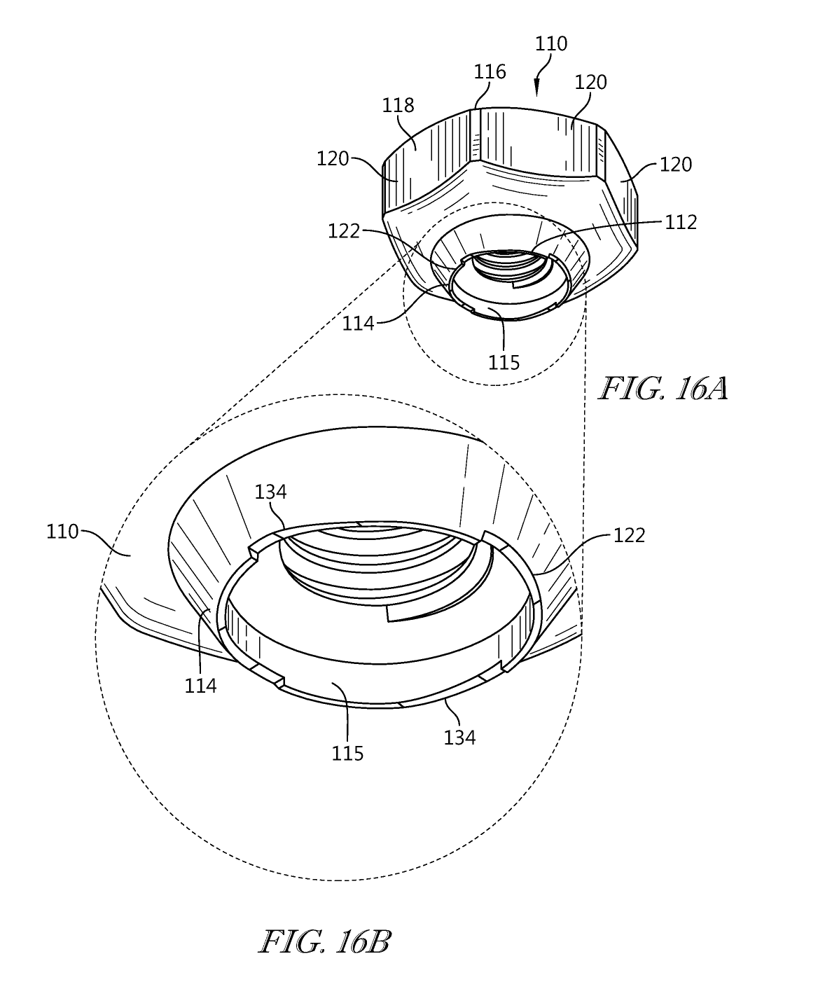

Installation of the fastener 30 will now be discussed in detail with reference to FIGS. 2, 3, 4A, 4B, 5, and 6-11. The fastener 30 is first inserted into aligned apertures in the workpiece 50, as seen in FIGS. 2 and 3. The drive nut 110 is disposed atop the enlarged head 48 of the body 32. Rotational movement of the drive nut 110 is minimized by interference between the malleable leading edge 122 of the drive nut 110 and the radial projections 52 of the enlarged head 48 of the body 32. The drive nut 110 is further rotationally restrained by an installation tool while the corebolt 60 is rotated. Rotation causes the corebolt 60 to thread into the body 32, which causes a bearing surface 128 of the enlarged head 68 of the corebolt 60 to push the sleeve 90 toward the workpiece 50. Pressure on the sleeve 90 drives the sleeve 90 up the tapered ramp 46 on the outer surface of the body 32 and into abutment with the workpiece 50, as seen in FIGS. 4A and 5. As seen in FIGS. 4B, 16A, and 16B, friction between the corebolt 50, the sleeve 90, and the body 32 biases rotation in the body 32, thereby causing the malleable leading edge 122 of the drive nut 110 to become embossed by the enlarged head 48 of the body 32 and the radial projections 52, deforming the malleable leading edge 122 at indentations 134 (FIGS. 16A and 16B). The deformation of the malleable leading edge 122, which can best be seen in FIGS. 16A and 16B, results in an abutment of the drive nut 110 against the enlarged head 48 that rotationally restrains the body 32 relative to the drive nut 110 and prevents excessive jamming of the drive nut 110 against the enlarged 48 of the body 32, which might otherwise induce excessive tensile stresses in the corebolt 60. Optionally, in a further embodiment, the protrusions 52 may be deformable and the leading edge 122 of the drive nut 110 may be rigid. In such embodiment, the rotational restriction of the body 32 would occur in the same manner as described above (the drive nut 110 would be restrained and the body 32 would be restrained with respect to the drive nut 110).

Referring again to FIGS. 4A and 5, which depicts the fastener 30 in a partially installed condition, once the sleeve 90 is in sufficient abutment with the workpiece 50, the torque required to continue threading the corebolt 60 through the body 32 exceeds the torque capacity at the break groove 72 in the corebolt 60, and the pintail 76 of the corebolt 60 breaks free from the remainder of the corebolt 60. The drive nut 110 may thereafter be utilized to check the unseating torque of the installed fastener 30 or may be removed and discarded, as seen in FIGS. 6-8.

Turning to FIGS. 9-11, after installation, the enlarged head 48 of the body 32 and any protruding portion of the corebolt 60 may be shaved flush with an outer surface 150 of the workpiece 50.

Although the mechanical coupling of the drive nut 110 to the body 32 is shown as a malleable leading edge 122 and projections 52, respectively, other means of coupling are also possible. One such alternative means would be radially-extending protrusions, such as knurls, on the abutment surface of the drive nut 110 that emboss a deformable ridge or circular ring on the enlarged head 48 of the body 32. Optionally, other means for coupling may include mating projections and apertures on either of the drive nut 110 and enlarged 48. Still optionally, any means of coupling known in the art may be utilized, including adhesive or metallurgical bonding or welding

Any of the embodiments described herein may be modified to include any of the structures or methodologies disclosed in connection with other embodiments or disclosed generally herein.

Further, although directional terminology, such as upper, lower, etc. may be used throughout the present specification, it should be understood that such terms are not limiting and are only utilized herein to convey the orientation of different elements with respect to one another.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I claim:

1. A fastener, comprising:
a body having a head with an exposed surface at a first end, a tapered ramp at a second end, a cylindrical shank disposed between the head and the tapered ramp, and a cylindrical passage formed through the body between the first and second end;
a cylindrical corebolt disposed within the passage of the body and having an enlarged head at a first end;
a sleeve having a cylindrical passage therethrough and movably disposed over a portion of the corebolt;
a drive nut disposed on the corebolt and having a leading edge disposed adjacent the exposed surface of the enlarged head of the body; and
means for rotationally coupling the drive nut and the body.

2. The fastener of claim 1, wherein the leading edge of the drive nut is deformable and protrusions extend outwardly from the head of the body to form the means for rotationally coupling the drive nut to the body.

3. The fastener of claim 2, wherein the deformable leading edge embosses the protrusions on the head of the body to form a mechanical interlock.

4. The fastener of claim 1, wherein the leading edge of the drive nut is rigid and deformable protrusions extend outwardly from the head of the body to form the means for rotationally coupling the drive nut to the body.

5. The fastener of claim 4, wherein rigid leading edge of the drive nut is pressed into the deformable protrusions of the head of the body to form a mechanical interlock.

6. A fastener, comprising:
a body having a head with an exposed surface at a first end, a tapered ramp at a second end, a cylindrical shank disposed between the head and the tapered ramp, and a cylindrical passage formed through the body between the first and second end;
a cylindrical corebolt disposed within the passage of the body and having an enlarged head at a first end;
a sleeve having a cylindrical passage therethrough and movably disposed over a portion of the corebolt;
a drive nut disposed on the corebolt and having a leading edge disposed adjacent the exposed surface of the enlarged head of the body; and
wherein the leading edge of the drive nut is rotationally coupled to protrusions extending outwardly from the head of the body.

7. The fastener of claim 6, wherein the leading edge of the drive nut is deformable and the protrusions are rigid.

8. The fastener of claim 7, wherein the protrusions emboss the leading edge of the drive nut to form a mechanical interlock.

9. The fastener of claim 6, wherein the leading edge of the drive nut is rigid and the protrusions are deformable.

10. The fastener of claim 9, wherein the rigid leading edge of the drive nut is pressed into the deformable protrusions of the head of the body to form a mechanical interlock.

11. A method of installing a fastener in a workpiece, the method comprising the steps of:
inserting a fastener into a workpiece, the fastener including:
a body having a head with an exposed surface at a first end, a tapered ramp at a second end, a cylindrical shank disposed between the head and the tapered ramp, and a cylindrical passage formed through the body between the first and second end;
a cylindrical corebolt disposed within the passage of the body and having an enlarged head at a first end;
a sleeve having a cylindrical passage therethrough and movably disposed over a portion of the corebolt; and
a drive nut disposed on the corebolt and having a leading edge disposed adjacent the exposed surface of the enlarged head of the body;
coupling the drive nut and the body;
rotating the corebolt while rotationally restraining the drive nut and the body; and
forming a blind head against the workpiece with the sleeve.

12. The method of claim 11, further including the step of rotationally restraining the drive nut by causing an installation tool to grasp and lock wrenching surfaces of the drive nut.

13. The method of claim 11, further including the step of providing the leading edge of the drive nut as a malleable edge.

14. The method of claim 13, further including the step of providing protrusions on an outer surface of the head of the body.

15. The method of claim 14, further including the step of forcing the malleable leading edge into the protrusions to form a coupling between the drive nut and the body.

16. The method of claim 11, further including the step of providing deformable protrusions on an outer surface of the head of the body.

17. The method of claim 16, further including the step of providing the leading edge of the core bolt as a rigid edge.

18. The method of claim 17. further including the step of forcing the rigid leading edge into the deformable protrusions to form a coupling between the drive nut and the body.

19. The method of claim 11, further including the steps of moving the enlarged head of the corebolt toward the workpiece and thereby forcing the sleeve over the tapered ramp of the body and into engagement with the workpiece.
